(19) United States
(12) Patent Application Publication
(10) Pub. No.: US 2009/0069532 A1
(43) Pub. Date: Mar. 12, 2009

(54) Polyimide Film

(75) Inventors: Chan Jae Ahn, Yongin-si (KR); Sang Min Song, Yongin-si (KR); Chung Seock Kang, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: Kolon Industries, Inc., Gwacheon-si (KR)

(21) Appl. No.: 12/161,369

(22) PCT Filed: Jan. 16, 2007
(86) PCT No.: PCT/KR2007/000254

§ 371 Date: Oct. 22, 2008

(30) Foreign Application Priority Data
Jan. 20, 2006 (KR) 10-2006-0006042

(51) Int. Cl. C08G 73/10

(52) U.S. Cl. 528/322

(57) ABSTRACT

Disclosed herein is a polyimide film having an elongation from 50 to 150%, a tensile elastic modulus from 4 to 8 GPa, a tensile strength from 150 to 500 MPa, and a hygroscopicity of 5% or less. The polyimide film has high elastic modulus and tensile strength and an excellent elongation, and thus the polyimide film exhibits excellent material properties when it is used as a base film for TAB and COF, and its properties can be usefully modified using an additive to improve productivity and processibility thereof.

### TECHNICAL FIELD

The present invention relates to a polyimide film, useful for a flexible circuit board, and a base film for a Chip On Film (hereinafter, COF) and Tape Automated Bonding (hereinafter, TAB), which has low hygroscopicity, high elastic modulus, and improved elongation.

### BACKGROUND ART

Generally, a polyimide film is widely used in the fields of electric/electronic materials, space/aeronautics, and telecommunications due to its excellent mechanical and thermal dimensional stability and high chemical stability.

In particular, the polyimide film is widely used as a material for a flexible circuit board, a base film for a TAB and a COF, which must have fine patterns because parts are becoming light, thin, short, and small.

TAB and COF technologies are technologies for sealing IC chips or LSI chips. That is, TAB and COF technologies are technologies for sealing the chips, in which a conductive pattern is formed on flexible tape and the chips are mounted thereon and are then sealed. In this technology, since the sealing material, such as the flexible tape, is small and has desirable flexibility, products can be manufactured in light, thin, short, and small forms.

High dimensional stability is required in order to use the polyimide film as a base film for TAB and COF. The reason is that dimensional changes can occur due to thermal contraction in a cooling process after the TAB and COF manufacturing processes, in which the polyimide film is bonded in a heated state, or a sputtering process, or dimensional changes can occur due to residual stress after an etching process. As a result, positional errors can occur in a process of bonding IC chips and LSI chips to the film for TAB and COF.

Further, TAB tape is exposed to a high temperature of 300° C. during a soldering process for electrically connecting the chips to a substrate. In this case, gas is generated while water, absorbed into the TAB tape, is vaporized, so that the dimensional changes of film occur and foam is also formed between the conductive pattern and the polyimide film. In order to overcome this problem, the polyimide film must have low hygroscopicity.

A polyimide film including 3,3′,4,4′-biphenyltetracarboxylic acid units and p-phenylenediamine units is widely used as a conventional polyimide film. The polyimide film including 3,3′,4,4′-biphenyltetracarboxylic acid units has a problem in that the elastic modulus is high, but water vapor transmissivity is low and the etching rate is low.

Japanese Unexamined Patent Publication No. 2001-270034 discloses a polyimide film, which includes pyromellitic dianhydride, 4,4′-diaminophenylether and p-phenylenediamine, and has a contraction percentage of 0.1%. Here, thermoplastic polyimide must be layered. However, the process of layering the thermoplastic polyimide is not easily performed, and requires a dedicated production apparatus.

### DISCLOSURE

### Technical Problem

Accordingly, the present inventors have made an effort to develop a polyimide film suitable for use as a flexible circuit board and a base film for TAB and COF, and thus have found a polyimide having a predetermined elongation and satisfying tensile elastic modulus, strength and hygroscopicity so as to be suitable for the above use, thereby completing the present invention.

Accordingly, an object of the present invention is to provide a polyimide film suitable for use as a flexible circuit board and as a base film for TAB and COF, which has low hygroscopicity, a low coefficient of hydroscopic expansion, a high elastic modulus, and an improved elongation.

### Technical Solution

In order to accomplish the above object, the present invention provides a polyimide film produced by imidizing polyamic acid, the polyamic acid being prepared by reacting diamines with dianhydrides, wherein the polyimide film has an elongation of 50 to 150%, a tensile elastic modulus of 4 to 8 GPa, a tensile strength of 150 to 500 MPa, and a hygroscopicity of 5% or less.

In the polyimide film of the present invention, the dianhydrides include biphenylcarboxylic dianhydride or derivatives thereof, and pyromellitic dianhydride or derivatives thereof; and the diamines include phenylenediamine or derivatives thereof, and diaminophenylether or derivatives thereof.

Further, the diamines include 3,4-diaminophenylether. In this case, the molar ratio of the 3,4-diaminophenylether to the diamines is from 0.7 to 0.05.

Further, in the polyimide film of the present invention, the molar ratio of the phenylenediamine to the diamines is from 0.8 to 0.1.

### Advantageous Effects

As described above, a polyamide film according to the present invention, having an elongation ranging from 50 to 150%, a tensile elastic modulus ranging from 4 to 8 GPa, a tensile strength ranging from 150 to 500 MPa, and a hygroscopicity of 5% or less, has a high elastic modulus and high tensile strength and an excellent elongation, so that the polyimide film exhibits excellent material properties when it is used as a base film for TAB and COF, and its properties can be usefully modified using an additive.

### Best Model

Hereinafter, the present invention will be described in detail.

The present invention provides a polyimide film having an elongation of 50 to 150%, a tensile elastic modulus of 4 to 8 GPa, a tensile strength of 150 to 500 MPa, and a hygroscopicity of 5% or less.

Here, the elongation, tensile strength and tensile elastic modulus are average values obtained by testing the polyimide film three times using a standard Instron testing apparatus based on ASTM D 882 regulations.

In the measurement of the hygroscopicity of the film, part of the film is cut, is placed in a chamber having a relative humidity of 100% for 48 hours, and is then analyzed using thermal gravimetric analysis. The hygroscopicity of the film is calculated by heating the polyimide film from 35° C. to 250° C. at a heating rate of 10° C./min and analyzing the change in the weight of the polyimide film.

Generally, a polyimide film has a low elongation. When the elongation is low, it is difficult to add an additive to the polyimide film, and the polyimide film has low crack resistance. The additive is used to impart slidability, thermal conductivity, electrical conductivity, and corona resistance to a polyimide film for TAB tape. The polyimide film must have a suitable elongation. When the additive is added to the polyimide film, the elongation thereof is decreased, so that fractures occur at the time that the polyimide film is produced, with the result that it is difficult to produce and process the polyimide film. Accordingly, when the elongation of the polyimide film is high, it is advantageous to impart functionality to the polyimide film and to increase the productivity thereof.

However, when the elongation of the polyimide film is increased, the elastic modulus and tensile strength thereof, which are important material properties, can be also decreased.

In the present invention, it was found that the tensile strength, tensile elastic modulus and hygroscopicity of the polyimide film are not decreased if it has a predetermined elongation.

That is, in the present invention, a correlation between other known material properties and elongation has been found in the case where the polyimide film is used as a flexible circuit board and a base film for TAB and COF. Methods for controlling the elongation, tensile strength, tensile elastic modulus, and hygroscopicity of the polyimide film within the above range are not limited. However, in the method of the present invention, dianhydrides, which are used for preparing polyamic acid, include biphenylcarboxylic dianhydride or derivatives thereof, and pyromellitic dianhydride or derivatives thereof; and diamines, which are also used for preparing the polyamic acid, include phenylenediamine or derivatives thereof, and diaminophenylether or derivatives thereof. In this case, the diaminophenylether or the derivatives thereof may be 4,4-diaminophenylether.

In particular, it is preferred that the diamines essentially include 3,4-diaminophenylether. The content of the 3,4-diaminophenylether may be adjusted such that the molar ratio of the 3,4-diaminophenylether to the diamines is from 0.7 to 0.05, and preferably about 0.5.

Furthermore, in the composition of the diamines, the mixing ratio of the phenylenediamine or derivatives thereof to the diamines and the mixing ratio of the diaminophenylether or derivatives thereof may be adjusted. In this case, the content of the phenylenediamine or derivatives thereof may be adjusted such that the molar ratio of the phenylenediamine to the diamines is from 0.8 to 0.1, and, preferably, the content of the diaminophenylether or derivatives thereof may be adjusted such that the molar ratio of the diaminophenylether to the diamines is at least 0.3.

Besides, those skilled in the art will accomplish the object of the present invention using various methods in consideration of the correlation of the tensile strength, tensile elastic modulus and hygroscopicity to the elongation, by precisely determining this correlation.

In order to more clearly understand the process of manufacturing of a polyimide film, a composition of the polyimide film and a method of forming a film will be described in detail below, but the invention is not limited thereto.

### Dianhydrides

The dianhydrides, which can be used in the present invention, may be 3,3′,4,4′-biphenyltetracarboxylic dianhydride, pyromellitic dianhydride, 3,3′,4,4′-benzophenonetetracarboxylic annhydride and p-phenylene-bis-trimellitic dianhydride, and, preferably, 3,3′,4,4′-biphenyltetracarboxylic dianhydride and pyromellitic dianhydride.

In particular, it is preferred that the 3,3′,4,4′-biphenyltetracarboxylic dianhydride be used as the dianhydride such that the molar ratio of the 3,3′,4,4′-biphenyltetracarboxylic dianhydride to the diamines ranges from 0.05 to 0.7 or from 0.1 to 0.6. The polyimide film including 3,3′,4,4′-biphenyltetracarboxylic acid units exhibits a high elastic modulus and low hygroscopicity. In contrast, the polyimide film is not suitable for use in an alkaline etching process because the polyimide film has poor etchability. Accordingly, it is preferred that the polyimide be produced by selecting an appropriate composition ratio thereof.

### Diamines

The diamines, which can be used in the present invention, may be p-phenylenediamine, 4,4′-diaminophenylether, 3,4-diaminophenylether and 2,4-diaminophenylether. Generally, p-phenylenediamine and 4,4′-diaminophenylether are used as the diamines. When it is required to add an additive or to obtain high processibility, 3,4-diaminophenylether is used as the diamines.

It is preferred that the molar ratio of the p-phenylenediamine to the diamines range from 0.8 to 0.1. The p-phenylenediamine is a monomer having linearity, compared to the diaminophenylether, and serves to decrease the thermal expansion coefficient. In contrast, when the content of the p-phenylenediamine is high, the flexibility of the film is decreased, and the film-forming property can be lost.

The 3,4-diaminophenylether or 2,4-diaminophenylether is a monomer having more flexibility than the 4,4-diaminophenylether. When the 3,4-diaminophenylether or 2,4-diaminophenylether is partially or entirely replaced with the 4,4-diaminophenylether, the elongation of the film can be further improved without worsening the material properties of the film.

As described above, it is preferred that the molar ratio of the 3,4-diaminophenylether to the diamines range from 0.7 to 0.05. Furthermore, the molar ratio of the diaminophenylether including the 3,4-diaminophenylether or the derivatives thereof to the diamines is preferably 0.3 or more.

### Method for Forming a Polyimide Film

The general method of forming a polyimide film is well known to those skilled in the art. For example, first, a polyamic acid solution is prepared by reacting the dianhydride with the diamine using an organic solvent. In this case, it is preferred that a general polar aprotic solvent, which is an amide solvent, be used as the organic solvent. The amide solvent may be N,N′-dimethylformamide, N,N′-dimethylacetamide or N-methyl-pyrrolidone. If necessary, the amide solvent may be used by combining two of the N,N′-dimethylformamide, N,N′-dimethylacetamide and N-methyl-pyrrolidone.

A monomer may be added in the form of powder, lumps, or a solution. At the beginning of the reaction, the monomer may be added in the form of powder. Furthermore, it is preferred that the monomer be added in the form of solution to adjust the polymerization viscosity.

The weight of the added monomer of a total polyamic acid solution in a state in which substantially equimolar amounts of diamine and dianhydride are added is referred to as “solid content”. It is preferred that the polymerization reaction be performed with a solid content from 10 to 30% or 12 to 23%.

A filler may be added to the polyimide film in order to improve various material properties such as slidability, thermal conductivity, electrical conductivity, and corona resistance. The filler is not limited, and may preferably be silica, titanium dioxide, alumina, silicon nitride, boron nitride, calcium hydrogen phosphate, calcium phosphate, mica, or the like.

The particle diameter of the filler may differ according to the thickness or kind of film, and the surface of the filler may also be modified. The average particle diameter of the filler is preferably 0.1 to 100 μm, and more preferably 0.1 to 25 μm.

The amount of the filler that is added is not particularly limited either , and may be determined depending on the kind of film to be modified, the kind and diameter of particles, the surface of the particles, and the like. It is preferred that the amount of the filler that is added be in the range from 10 ppm to 5% based on the solid content of the polyamic acid solution after the completion of the polymerization reaction. When the added amount of the filler exceeds this range, the material properties of the polyimide are deteriorated. In contrast, when the added amount of the filler is less than this range, the modification to the polyimide film is insufficient.

The filler may be added at the beginning of the polymerization reaction or after the completion of the polymerization reaction. Furthermore, the filler may be added upon the catalyst mixing process to prevent the contamination of a reactor. Accordingly, the method and time of the addition of the filler are not limited.

The polyamic acid solution is mixed with a catalyst and is then applied to a support. It is preferred that a dehydration catalyst containing acid anhydride and tertiary amines be used as the catalyst. The acid anhydride, for example, is acetic acid anhydride. The tertiary amines, for example, are isoquinoline, β-picoline, pyridine, and the like.

The added amount of the acid anhydride can be calculated from the molar ratio of the o-carboxylic amide functional group to the polyamic acid solution. It is preferred that the molar ratio of the acid anhydride range from 1.0 to 5.0.

The added amount of the tertiary amine can be calculated from the molar ratio of the o-carboxylic amide functional group to the polyamic acid solution. It is preferred that the molar ratio of the tertiary amine range from 0.2 to 3.0.

The mixture of acid anhydride and amines or the mixture of acid anhydride, amines and solvent may be used as the catalyst.

The applied film is gelled on the support through drying and heat treatment. The gelation temperature of the applied film preferably ranges from 100 to 250° C. A glass plate, aluminum foil, a circular stainless belt, a stainless drum, or the like may be used as the support.

The time required for gelling the film varies depending on the temperature, the kind of support, the amount of the applied polyamic acid solution and the mixing conditions of the catalyst, and is not limited. The time required for gelling the film preferably ranges from 5 to 30 minutes.

The gelled film is separated it from the support, and dried and imidized by performing the heat treatment. Heat treatment is performed at a temperature from 100 to 500° C. for a period ranging from 1 to 30 minutes. The heat treatment is performed with the gelled film fixed to a supporting die.

The gelled film may be fixed using a pin type frame or a clip type frame.

After the heat treatment is performed, the content of residual volatile component of the film is 5% or less, and preferably 3% or less.

Residual stress in the film, which occurs in a film forming process, is removed by heat-treating the film again under predetermined tension. In this case, since the tension condition and the temperature condition relate to each other, the tension condition may be different according to the temperature condition. It is preferred that the heat treatment be performed at a temperature ranging from 100 to 500° C., under a tension of 50N or less and for a time period ranging from 1 minute to 1 hour.

### Mode for Invention

Hereinafter, the present invention will be described in detail based on examples. The present invention is not limited to the examples.

### EXAMPLE 1

995 g of N,N′-dimethyl formamide (DMF), which is a solvent, was put into a jacket reactor having a volume of 2 L. 3.65 g of p-phenylenediamine (p-PDA), and 2.901 g of 4,4′-diaminophenylene ether (ODA) were added as diamine to the reactor at a temperature of 30° C. After the mixture was stirred and the monomer was determined to have been dissolved, 5.64 g of 3,3′,4,4′-biphenyltetracarboxylic dianhydride (BPDA) was added thereto. Next, the calorific value in the reactor was determined, and the mixture in the reactor was then cooled to a temperature of 30° C. after exothermic reaction was ended. Thereafter, 5.96 g of pyromellitic dianhydride (PMDA) was added to the reactor, and the mixture was then stirred at a predetermined temperature for 1 hour.

After the stirring process, the reactor was heated to a temperature of 40° C. Then, 4.98 g of PMDA having a concentration of 7.2% was added to the reactor and was then stirred at a predetermined temperature for 2 hours. During the stirring process, the reactor was depressurized to a pressure of 1 torr, so that foam in the polyamic acid solution, which was generated during the reaction, could be removed.

After the reaction completed, the solid content of the polyamic acid solution was 18.5 wt %, and the viscosity thereof was 5300 poise. The molar ratio of the added monomer was 40% BPDA, 60% PMDA, 30% ODA, and 70% PDA.

100 g of this polyamic acid solution was uniformly mixed with 50 g of a catalytic solution (7.2 g of isoquinoline and 22.4 g of acetic anhydride), was applied to a stainless plate, was cast to a thickness of 100 μm, and was then dried for 5 minutes using hot air at 150° C. Thereafter, the film was separated from the stainless plate, and was then fixed to the frame using pins.

The frame provided with the film was put into a vacuum oven, was gradually heated from 100° C. to 350° C. for 30 minutes, and was then gradually cooled. Thereafter, the film was separated from the frame.

Part of the film was cut, was put in a chamber having a relative humidity of 100% for 48 hours, and was then analyzed using a thermal gravimetric analysis method. The hygroscopicity of the film was determined by heating the film from 35° C. to 250° C. at a heating rate of 10° C./min and analyzing the change in the weight of the polyimide film.

Further, after the film forming process, part of the sample was cut to have an area of 6 mm×30 mm, and the thermal expansion coefficient of the sample was measured using a Mettler thermomechanical analysis apparatus. The sample was hooked using a quartz hook, and a force of 0.005 N was applied to the sample. Then, the sample was heated from 35° C. to 350° C. at a heating rate of 10° C./min and was then gradually cooled. Thereafter, the sample was re-heated from 40° C. to 250° C. under the same conditions. The thermal expansion coefficient of the sample was measured in a range of 40° C. to 250° C.

The elongation, tensile strength and tensile elastic modulus are average values obtained by testing the polyimide film three times using a standard Instron testing apparatus based on ASTM D 882 regulations. The results are given in Table 2.

### EXAMPLE 2

After 995 g of a solvent was put into the reactor, 2.03 g of 4,4-ODA, 0.87 g of 3,4-ODA and 3.65 g of p-PDA were added to the reactor. When the diamine had completely dissolved, 5.64 g of BPDA and 5.96 g of PMDA were separately added and the mixture was stirred. After the reaction was completed, 4.97 g of PMDA solution was added in stages.

Reaction conditions such as reaction time, reaction temperature, etc. were the same as in Example 1.

After the reaction, a film forming process was performed as in Example 1, and the material properties of the film obtained through the film forming process were measured. The results are given in Table 2.

### EXAMPLE 3

After 995 g of a solvent was put into the reactor, 2.44 g of 4,4-ODA and 3.65 g of p-PDA were added into the reactor. When the diamine had completely dissolved, 5.71 g of BPDA and 6.03 g of PMDA were separately added and the mixture was stirred. After the reaction was completed, 5.04 g of PMDA solution was added in stages. Reaction conditions, such as reaction time, reaction temperature, etc. were the same as in Example 1.

After the reaction, a film forming process was performed as in Example 1, and the material properties of the film obtained through the film forming process were measured. The results are given in Table 2.

### EXAMPLE 4

After 995 g of a solvent was put into the reactor, 1.71 g of 4,4-ODA, 0.73 g of 3,4-ODA and 3.65g of p-PDA were added into the reactor. When the diamine had completely dissolved, 5.71 g of BPDA and 6.03 g of PMDA were separately added and the mixture was stirred. After the reaction was completed, 5.04 g of PMDA solution was added in stages.

Reaction conditions, such as reaction time, reaction temperature, etc. were the same as in Example 1.

After the reaction, a film forming process was performed as in Example 1, and the material properties of the film obtained through the film forming process were measured. The results are given in Table 2.

### EXAMPLE 5

After 995 g of a solvent was put into the reactor, 2.42 g of 4,4-ODA and 3.92 g of p-PDA were added into the reactor. When the diamine had completely dissolved, 6.36 g of BPDA and 5.44 g of PMDA were separately added and the mixture was stirred. After the reaction was completed, 5.06 g of PMDA solution was added in stages. Reaction conditions such as reaction time, reaction temperature, etc. were the same as in Example 1.

After the reaction, a film forming process was performed as in Example 1, and the material properties of the film obtained through the film forming process were measured. The results are given in Table 2.

### EXAMPLE 6

After 995 g of a solvent was put into the reactor, 1.69 g of 4,4-ODA, 0.73 g of 3,4-ODA and 3.92 g of p-PDA were added into the reactor. When the diamine had completely dissolved, 6.36 g of BPDA and 5.44 g of PMDA were separately added and the mixture was stirred. After the reaction was completed, 5.06 g of PMDA solution was added in stages.

Reaction conditions such as reaction time, reaction temperature, etc. were the same as in Example 1.

After the reaction, a film forming process was performed as in Example 1, and the material properties of the film obtained through the film forming process were measured. The results are given in Table 2.

### EXAMPLE 7

After 995 g of a solvent was put into the reactor, 2.84 g of 4,4-ODA and 3.58 g of p-PDA were added into the reactor. When the diamine had completely dissolved, 6.91 g of BPDA and 5.16 g of PMDA were separately added and the mixture was stirred. After the reaction was completed, 5.03 g of PMDA solution was added in stages. Reaction conditions such as reaction time, reaction temperature, etc. were the same as in Example 1.

After the reaction, a film forming process was performed as in Example 1, and the material properties of the film obtained through the film forming process were measured. The results are given in Table 2.

### EXAMPLE 8

After 995 g of a solvent was put into the reactor, 1.99 g of 4,4-ODA, 0.85 g of 3,4-ODA and 3.58g of p-PDA were added into the reactor. When the diamine had completely dissolved, 6.91 g of BPDA and 5.16 g of PMDA were separately added and the mixture was stirred. After the reaction was completed, 5.03 g of PMDA solution was added in stages. Reaction conditions such as reaction time, reaction temperature, etc. were the same as in Example 1.

After the reaction, a film forming process was performed as in Example 1, and the material properties of the film obtained through the film forming process were measured. The results are given in Table 2.

### COMPARATIVE EXAMPLE 1

After 994.5 g of a solvent was put into the reactor, 5.09 g of p-PDA were added into the reactor. When the diamine had completely dissolved, 12.38 g of BPDA and 1.03 g of PMDA were separately added and the mixture was stirred. After the reaction was completed, 5.58 g of PMDA solution was added in stages. Reaction conditions such as reaction time, reaction temperature, etc. were the same as in Example 1.

After the reaction, a film forming process was performed as in Example 1, and the material properties of the film obtained through the film forming process were measured. The results are given in Table 2.

### COMPARATIVE EXAMPLE 2

After 995.3 g of a solvent was put into the reactor, 1.10 g of 4,4-ODA and 5.37 g of p-PDA were added into the reactor. When the diamine had completely dissolved, 12.03 g of PMDA was separately added and the mixture was stirred.

After the reaction was completed, 5.01 g of PMDA solution was added in stages. Reaction conditions such as reaction time, reaction temperature, etc. were the same as in Example 1.

After the reaction, a film forming process was performed as in Example 1, and the material properties of the film obtained through the film forming process were measured. The results are given in Table 2.

TABLE 1

| | | | | | | | | | | Comp. | Comp. |
|---|---|---|---|---|---|---|---|---|---|---|---|
| | | Example | Example | Example | Example | Example | Example | Example | Example | Example | Example |
| | | 1 | 2 | 3 | 4 | 5 | 6 | 7 | 8 | 1 | 2 |
| BPDA | | 40 | 40 | 40 | 40 | 45 | 45 | 50 | 50 | 90 | 0 |
| PMDA | | 60 | 60 | 60 | 60 | 55 | 55 | 50 | 50 | 10 | 100 |
| PDA | | 70 | 70 | 75 | 75 | 75 | 75 | 70 | 70 | 100 | 90 |
| ODA | | 30 | 30 | 25 | 25 | 25 | 25 | 30 | 30 | 0 | 10 |
| ODA | 4, 4 | 100 | 70 | 100 | 70 | 100 | 70 | 100 | 70 | 0 | 0 |
| molar | 3, 4 | 0 | 30 | 0 | 30 | 0 | 30 | 0 | 30 | 0 | 0 |
| ratio | | | | | | | | | | | |
| (mol %) | | | | | | | | | | | |

TABLE 2

| | Tensile | | | Linear | |
|---|---|---|---|---|---|
| | elastic | Tensile | | expansion | Hygro- |
| | modulus | strength | Elongation | coefficient | scopicity |
| | (GPa) | (MPa) | (%) | (ppm/° C.) | (%) |
| Example 1 | 5.5 | 303.1 | 51.2 | 15 | 2.4 |
| Example 2 | 5.2 | 300.3 | 63.6 | 16 | 2.2 |
| Example 3 | 5.4 | 310.4 | 48.2 | 16 | 2.4 |
| Example 4 | 5.5 | 310.4 | 52.4 | 15 | 2.5 |
| Example 5 | 5.5 | 311.2 | 55.0 | 15 | 2.1 |
| Example 6 | 5.5 | 312.6 | 56.9 | 15 | 2.1 |
| Example 7 | 5.5 | 300.4 | 83.1 | 17 | 2.2 |
| Example 8 | 5.5 | 300.8 | 83.4 | 17 | 2.1 |
| Comp. | 8.0 | 51.1 | 40.6 | 14 | 1.9 |
| Example 1 | | | | | |
| Comp. | 3.8 | 304.1 | 70.1 | 23 | 3.2 |
| Example 2 | | | | | |

1. A polyimide film produced by imidizing polyamic acid, the polyamic acid being prepared by reacting diamines with dianhydrides, wherein the polyimide film has an elongation from 50 to 150%, a tensile elastic modulus from 4 to 8 GPa, a tensile strength from 150 to 500 MPa, and a hygroscopicity of 5% or less.

2. The polyimide film according to claim 1, wherein the dianhydrides comprise biphenylcarboxylic dianhydride or derivatives thereof, and pyromellitic dianhydride or derivatives thereof; and the diamines comprise phenylenediamine or derivatives thereof, and diaminophenylether or derivatives thereof.

3. The polyimide film according to claim 1, wherein the diamines comprise 3,4-diaminophenylether as the diaminophenylether or derivatives thereof

4. The polyimide film according to claim 3, wherein the molar ratio of the 3,4-diaminophenylether to the diamines ranges from 0.7 to 0.05.

5. The polyimide film according to claim 1, wherein the molar ratio of the phenylenediamine to the diamines is from 0.8 to 0.1.

6. The polyimide film according to claim 3, wherein the molar ratio of the phenylenediamine to the diamines is from 0.8 to 0.1.

7. The polyimide film according to claim 2, wherein the diamines comprise 3,4-diaminophenylether as the diaminophenylether or derivatives thereof
